(19) United States
(12) Patent Application Publication
(10) Pub. No.: US 2019/0129073 A1
(43) Pub. Date: May 2, 2019

(54) CAMERA LENS AND CAMERA LENS ASSEMBLY HAVING SAME

(71) Applicant: Dong Won HYUN, Gyeonggi-do (KR)

(72) Inventor: Dong Won HYUN, Gyeonggi-do (KR)

(21) Appl. No.: 16/098,786

(22) PCT Filed: Apr. 2, 2018
(86) PCT No.: PCT/KR2018/003851

§ 371 Date: Nov. 2, 2018

(30) Foreign Application Priority Data
Mar. 31, 2017 (KR) 10-2017-0041935

(51) Int. Cl. G02B 3/00; G02B 13/00

(52) U.S. Cl. CPC G02B 3/00; G02B 13/00

(57) ABSTRACT

Provided are a camera lens selectively transmitting external lights and a camera lens assembly including the same. The camera lens includes a lens body having a front surface and a rear surface and including a central optical unit formed at a center thereof. The camera lens also includes a plurality of optical fiber units arranged such that at least some thereof are included in the lens body, and having a different refractive index than the lens body.

### CROSS REFERENCE TO RELATED APPLICATIONS

This application is the National Stage of the International Application No. PCT/KR2018/003851, having an International Filing Date of 2 Apr. 2018, which designated the United States of America, and which claims priority from and the benefit of Korean Patent Application No. 10-2017-0041935, filed on 31 Mar. 2017, the disclosures of which are incorporated herein by reference in their entireties.

### BACKGROUND

### 1. Field

The present disclosure relates to devices, and more particularly, to a camera lens mounted in a camera and a camera lens assembly including the camera lens.

### 2. Description of Related Developments

The number and types of devices using camera lenses have increased as networking for capturing and uploading pictures or videos to a social network service (SNS) has expanded. Accordingly, the demand for functionally specialized camera lenses is expected to increase in the future as well.

A camera lens has an aperture in order to secure a light amount. In general, an aperture is arranged at the center of a lens, and the size of an aperture is small in order to minimize the interference during photographing and reduce the size of a lens. However, when the size of an aperture is small, since there is a limit to securing a sufficient light amount, it is difficult to photograph in a dark place.

Thus, research on a photographing device capable of ensuring a sufficient light amount to improve image quality during photographing even in a dark place is necessary.

### SUMMARY

Provided is a camera lens capable of aligning lights incident thereon.

According to an aspect of the present disclosure, a camera lens includes a lens body having a front surface and a rear surface and including a central optical unit formed at a center thereof; and a plurality of optical fiber units arranged such that at least some thereof are included in the lens body, and having a different refractive index than the lens body.

The camera lens according to an embodiment of the present disclosure may adjust the amount of light passing therethrough, thereby improving the focal depth thereof and adjusting the brightness of a formed image.

Also, since the camera lens according to embodiments of the present disclosure may align incident lights, the camera lens itself may perform a function of an aperture. Also, even when an aperture of the related art is installed together with the camera lens according to embodiments of the present disclosure, since the size of an opening of an aperture may be increased, a sufficient light amount may be secured and thus the image quality may be improved in the case of photographing in a dark place. However, the scope of the present disclosure is not limited to these effects.

### BRIEF DESCRIPTION OF DRAWINGS

FIG. 1A is a cross-sectional view illustrating a camera lens assembly according to an embodiment of the present disclosure.

FIG. 1B is a cross-sectional view illustrating a camera lens assembly according to another embodiment of the present disclosure.

FIG. 2 is a perspective view illustrating a camera lens of FIG. 1.

FIG. 3 is a plan view illustrating a camera lens of FIG. 2.

FIG. 4 is a cross-sectional view taken along line IV-IV of FIG. 2.

FIG. 5 is a cross-sectional view illustrating a modification of the camera lens of FIG. 2.

FIGS. 6A to 6F are cross-sectional views illustrating other modifications of the camera lens of FIG. 2.

FIG. 7 is a perspective view illustrating a camera lens according to another embodiment of the present disclosure.

FIG. 8 is a cross-sectional view taken along line VIII-VIII of FIG. 7.

FIGS. 9A to 9G are cross-sectional views illustrating modifications of the camera lens of FIG. 7.

FIG. 10 is a perspective view illustrating a camera lens according to another embodiment of the present disclosure.

FIG. 11 is a perspective view illustrating a camera lens according to another embodiment of the present disclosure.

FIG. 12 is a perspective view illustrating a camera lens according to another embodiment of the present disclosure.

FIG. 13 is a perspective view illustrating a camera lens according to another embodiment of the present disclosure.

FIG. 14 is a perspective view illustrating a camera lens according to another embodiment of the present disclosure.

FIG. 15 is a perspective view illustrating a camera lens according to another embodiment of the present disclosure.

FIG. 16 is a conceptual diagram illustrating external lights incident on the camera lens of FIG. 2.

### DETAILED DESCRIPTION

According to an aspect of the present disclosure, a camera lens includes a lens body having a front surface and a rear surface and including a central optical unit formed at a center thereof; and a plurality of optical fiber units arranged such that at least some thereof are included in the lens body, and having a different refractive index than the lens body.

Also, the optical fiber units may be arranged outside and around the central optical unit.

Also, the optical fiber unit may include a first fiber unit arranged adjacent to an outer side of the central optical unit and a second fiber unit arranged adjacent to the first fiber unit in a radial direction.

Also, an angle formed between a length direction of the first fiber unit and a thickness direction of the lens body may be less than an angle formed between a length direction of the second fiber unit and the thickness direction of the lens body.

Also, the optical fiber unit may further include a third fiber unit arranged on an outer side of the second fiber unit in the radial direction, a distance between the first fiber unit and the second fiber unit may be greater than a distance between the second fiber unit and the third fiber unit, and a diameter of the first fiber unit may be greater than a diameter of the second fiber unit.

Also, the optical fiber unit may further include a third fiber unit arranged on an outer side of the second fiber unit in the radial direction, a distance between the first fiber unit and the second fiber unit may be less than a distance between the second fiber unit and the third fiber unit, and a diameter of the first fiber unit may be less than a diameter of the second fiber unit.

Also, the optical fiber units may be connected to each other and arranged in a fiber loop.

Also, the optical fiber unit may be arranged such that a length direction of the optical fiber unit and a thickness direction of the lens body form a certain angle therebetween.

Also, a plurality of optical fiber units may be arranged in a radial direction of the central optical unit, and diameters of the optical fiber units may decrease in the radial direction.

Also, the optical fiber unit may extend from the front surface to the rear surface of the lens body.

Also, the optical fiber unit may be inserted into the front surface or the rear surface of the lens body.

Also, the optical fiber unit may be arranged in the lens body.

Also, the optical fiber unit may be arranged more adjacent to the front surface than the rear surface of the lens body or more adjacent to the rear surface than the front surface of the lens body.

Also, the optical fiber unit may be formed such that an outer wall thereof is tapered in a thickness direction of the lens body.

Also, the optical fiber unit may include any one selected from glass fiber and optical fiber.

Also, at least some of external lights incident on the optical fiber unit may be totally reflected at an inner wall of the optical fiber unit.

Also, lights directed to the central optical unit may pass through the central optical unit, and some of the lights directed to the optical fiber unit may pass through the optical fiber unit.

Also, a light absorbing paint may be applied on an outer wall of the optical fiber unit.

According to another aspect of the present disclosure, a camera lens assembly includes a housing; a camera lens arranged in the housing, and an image sensor arranged to face the lens such that lights that passed through the lens converge on the image sensor, wherein the camera lens may include a lens body having a front surface and a rear surface and including a central optical unit formed at a center thereof; and a plurality of optical fiber units arranged such that at least some thereof are included in the lens body, and having a different refractive index than the lens body.

Also, lights directed to the central optical unit may pass through the central optical unit, and some of the lights directed to the optical fiber unit may pass through the optical fiber unit.

The present disclosure will be clearly understood with reference to embodiments described in detail in conjunction with the accompanying drawings. The present disclosure may, however, be embodied in many different forms and should not be construed as being limited to the embodiments set forth herein; rather, these embodiments are provided so that the present disclosure will be thorough and complete and will fully convey the scope of the present disclosure to those of ordinary skill in the art. The scope of the present disclosure will be defined by the appended claims. The terms used herein are to describe the embodiments and are not intended to limit the scope of the present disclosure. As used herein, the singular forms “a”, “an”, and “the” are intended to include the plural forms as well, unless the context clearly indicates otherwise. It will be understood that the terms such as “comprise”, “include”, and “have” used herein specify the presence of stated steps, operations, components, and/or elements but do not preclude the presence or addition of one or more other steps, operations, components, and/or elements. Although terms such as “first” and “second” may be used herein to describe various elements or components, these elements or components should not be limited by these terms. These terms are only used to distinguish one element or component from another element or component.

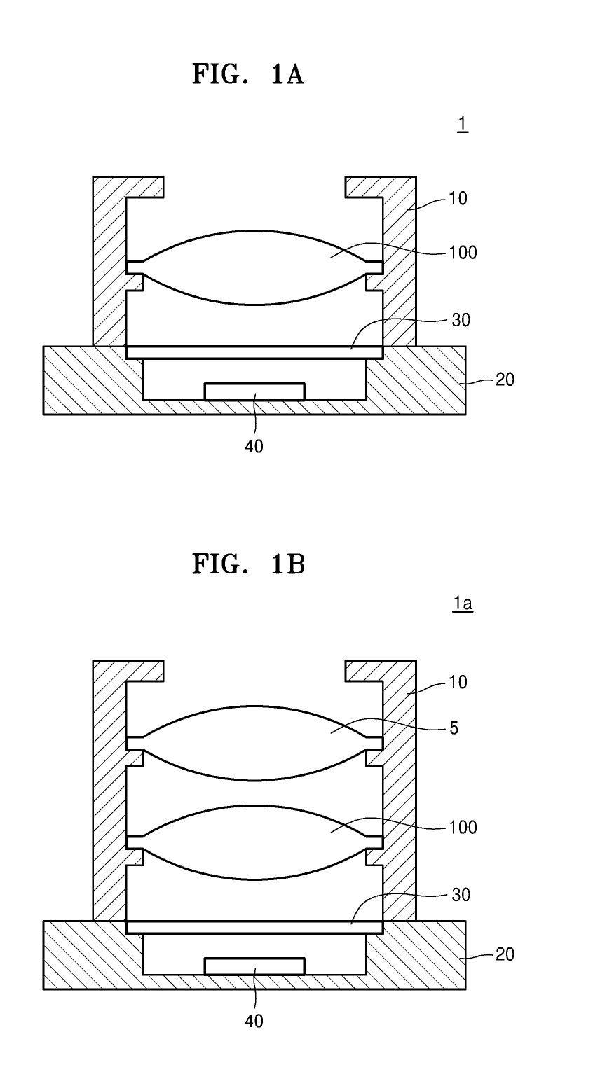

FIG. 1A is a cross-sectional view illustrating a camera lens assembly 1 according to an embodiment of the present disclosure, and FIG. 1B is a cross-sectional view illustrating a camera lens assembly 1a according to another embodiment of the present disclosure.

Referring to FIG. 1A, the camera lens assembly 1 may include a first housing 10, a second housing 20, a filter unit 30, an image sensor 40, and a camera lens 100.

The camera lens 100 may be arranged in the first housing 10. Also, a reflection filter (not illustrated) may be arranged in the first housing 10. The second housing 20 may be coupled to the first housing 10 and may be a portion of a camera body (not illustrated). Also, the second housing 20 may be formed integrally with the first housing 10. The filter unit 30 may be provided spaced apart from the camera lens 100 to filter the light that passed through the camera lens 100. The image sensor 40 may be installed in the second housing 20 to form an image from the light that enters the camera lens assembly 1.

The camera lens 100 may be arranged in the first housing 10, and an optical fiber unit of the camera lens 100 may perform a function of an aperture as described below. That is, the camera lens 100 may have both a function of an aperture and a function of a camera lens of the related art.

Referring to FIG. 1B, the camera lens assembly 1a may include a camera lens unit 5. The camera lens unit 5 may include one of camera lenses of the related art. A camera lens 100 may be arranged together with the camera lens unit 5 such that an optical fiber unit thereof may perform a function of an aperture. Also, the camera lens 100 may have both a function of an aperture and a function of a camera lens of the related art.

In another embodiment, a plurality of camera lenses 100 may be arranged in a camera lens assembly. Also, a plurality of camera lens units 5 may be arranged in the camera lens assembly.

An aperture (not illustrated) may be installed together with the camera lens 100. The aperture may adjust the size of an opening to adjust the amount of light aligned in the camera lens 100.

The camera lens 100 may transmit some of incident lights and selectively transmit other lights to form a clear image. That is, since the camera lens 100 may improve the focal depth, it may perform a function of an aperture and adjust the brightness of an image. Hereinafter, the camera lens 100 will be described in detail.

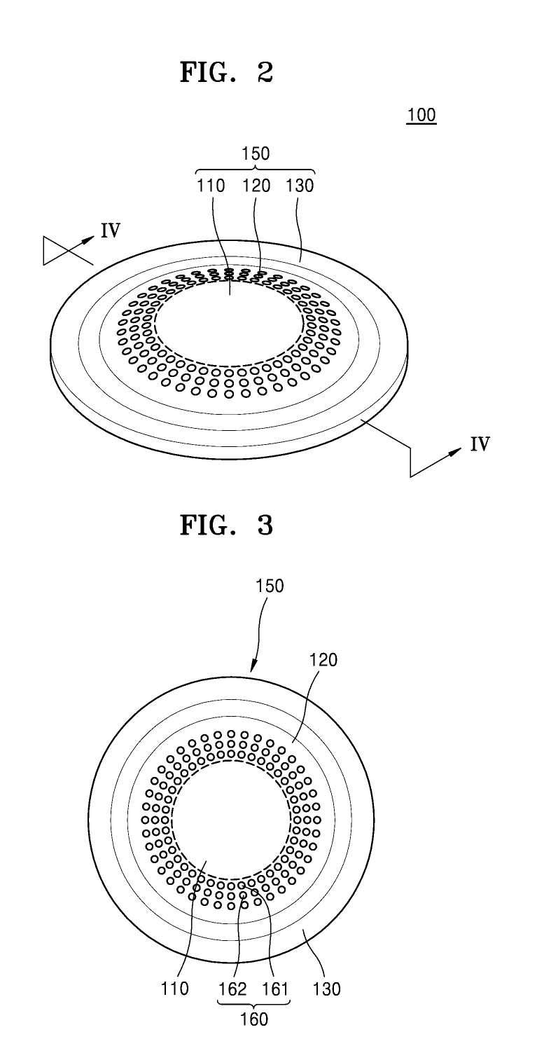

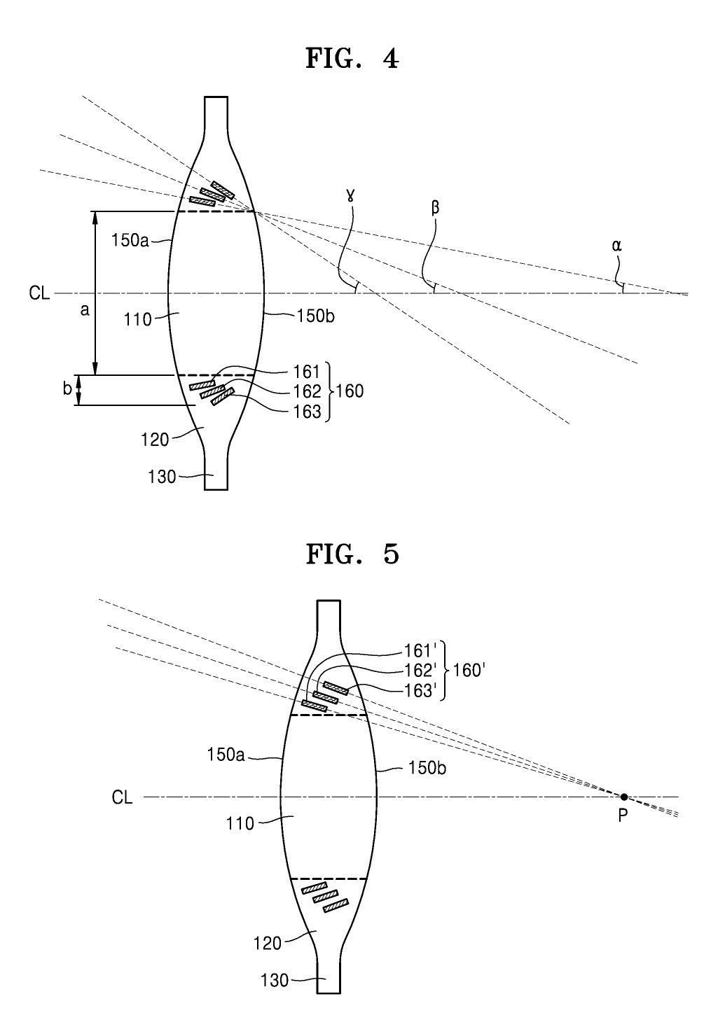

FIG. 2 is a perspective view illustrating the camera lens 100 of FIG. 1, FIG. 3 is a plan view illustrating the camera lens 100 of FIG. 2, and FIG. 4 is a cross-sectional view taken along line IV-IV of FIG. 2.

Referring to FIGS. 2 to 4, the camera lens 100 may include a lens body 150 and an optical fiber unit 160. The camera lens 100 may be mounted in a general optical device as illustrated in FIGS. 1A and 1B.

Hereinafter, an incidence angle of light incident on the camera lens 100 is defined as an angle between the direction of the incident light and the direction of a central line CL in the thickness direction of the camera lens 100. Thus, a small incidence angle may mean that light is incident substantially perpendicular to the camera lens 100, and a great incidence angle may mean that light is incident toward the camera lens 100 from the side surface of the camera lens 100.

The lens body 150 may have a front surface 150a and a rear surface 150b. The front surface 150a may correspond to a region where an external light is incident. The rear surface 150b may correspond to the front surface 150a and may be arranged to face the image sensor 40. The external light may enter through the front surface 150a, move through the lens body 150, and pass through the rear surface 150b.

The lens body 150 may include a central optical unit 110, a transition unit 120 where the optical fiber unit 160 is arranged, and an edge unit 130. The lens body 150 may be a region through which the external light is transmitted.

The lens body 150 may include a relatively hard material, a relatively soft flexible semi-rigid material, or a combination thereof. For example, the lens body 150 may include polymethyl methacrylate (PMMA), polysulfone (PSF), or other relatively-hard inert optical materials. Also, the lens body 150 may include silicone resin, hydrogel, thermolabile materials, or other flexible and semi-rigid optical materials. The lens body 150 may include an optical material used in a camera lens of the related art.

The central optical unit 110 may be formed to be convex in a first direction that is the thickness direction of the lens body 150. The central optical unit 110 may be formed such that the front surface 150a is convex in the first direction that is the thickness direction or the rear surface 150b is convex in the first direction. Also, as illustrated in FIG. 4, the front surface 150a and the rear surface 150b may be formed to be convex. In another embodiment, at least one of the front surface 150a and the rear surface 150b may be formed to be concave. Hereinafter, for convenience of description, a case where the front surface 150a and the rear surface 150b are formed to be convex will be mainly described.

The central optical unit 110 may be arranged at the center of the lens body 150. The central optical unit 110 may receive most of the external lights incident on the camera lens 100.

The transition unit 120 may surround the central optical unit 110 and the optical fiber unit 160 may be arranged therein. The transition unit 120 may be formed such that the thickness thereof in the first direction decreases away from the central optical unit 110 toward the edge unit 130. In another embodiment, the transition unit 120 may be formed to have a certain groove to discriminate the central optical unit 110 from the edge unit 130.

The optical fiber unit 160 may be arranged around an outer portion of the central optical unit 110. The optical fiber unit 160 may be arranged such that at least a portion thereof is included in the central optical unit 110. The optical fiber unit 160 may be formed to extend in the first direction. Also, a cross section of the optical fiber unit 160 may be polygonal or circular. For example, the optical fiber unit 160 may be formed in the shape of a substantially polygonal pillar or in the shape of a substantially circular pillar.

A plurality of optical fiber units 160 may be arranged along the central optical unit 110 to form an annular band. Also, a plurality of optical fiber units 160 may be arranged in the radial direction of the central optical unit 110. The optical fiber units 160 may be arranged consecutively to each other while partially overlapping each other. Also, the optical fiber units 160 may be arranged at certain intervals. Hereinafter, for convenience of description, a case where the three fiber units are regularly arranged at certain intervals will be mainly described.

Particularly, the optical fiber unit 160 may include a first fiber unit 161 adjacent to the central optical unit 110 and arranged in a circular shape along the central optical unit 110, a second fiber unit 162 arranged on an outer side of the first fiber unit 161 in the radial direction, and a third fiber unit 163 arranged on an outer side of the second fiber unit 162 in the radial direction.

Each of the first fiber unit 161, the second fiber unit 162, and the third fiber unit 163 may be formed to extend from the front surface 150a to the rear surface 150b.

The optical fiber unit 160 may form a certain angle with respect to each of the length direction and the first direction. The optical fiber unit 160 may form a certain angle with respect to the central line CL of the central optical unit 110. Also, the angle may increase in the radial direction of the central optical unit 110. Since the optical fiber unit 160 is arranged at a certain angle, when a light with a great incidence angle is incident thereon, the light may be reflected by the side wall of the optical fiber unit 160. In this case, since the optical fiber unit 160 has a slope, the incidence area thereof may be increased and thus the light may be effectively aligned.

Particularly, the length direction of the first fiber unit 161 and the central line CL of the central optical unit 110 may form a first angle α, the length direction of the second fiber unit 162 and the central line CL of the central optical unit 110 may form a second angle β, and the length direction of the third fiber unit 163 and the central line CL of the central optical unit 110 may form a third angle γ. The third angle γ may be greater than the second angle β and greater than the first angle α. Also, the second angle β may be greater than the first angle α. Thus, the optical fiber unit 160 may be arranged such that the arrangement angle thereof decreases away from the central line CL in the radial direction.

FIG. 5 is a cross-sectional view illustrating a modification of the camera lens 100 of FIG. 2.

Referring to FIG. 5, a center of an optical fiber unit 160′ in the length direction may be formed in a region P. Extension lines of a first fiber unit 161′, a second fiber unit 162′, and a third fiber unit 163′ in the length direction may be arranged to collect in the region P. The optical fiber unit 160′ may converge the external lights on one region to secure a field of view.

Referring to FIG. 4, a distance “b” of a region where the optical fiber unit 160 is arranged may be smaller than a diameter “a” of the central optical unit 110. Thus, most of the lights incident from outside may pass through the central optical unit 110 and only some lights thereof with a great incidence angle may be reflected by the optical fiber unit 160 to align the lights. Hereinafter, the incidence angle may be an angle between the first direction and the light movement direction. This will be described below in detail.

The refractive index of the optical fiber unit 160 may be different from the refractive index of the central optical unit 110. For example, the refractive index of the optical fiber unit 160 may be greater than the refractive index of the central optical unit 110, or the refractive index of the optical fiber unit 160 may be smaller than the refractive index of the central optical unit 110. Thus, the light incident on the optical fiber unit 160 may be selectively transmitted according to the incidence angle. For example, the optical fiber unit 160 may include any one selected from optical fiber and glass fiber.

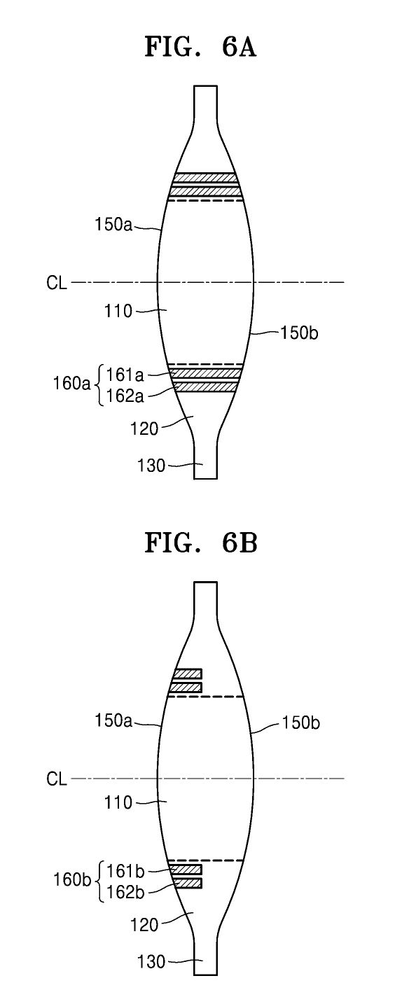

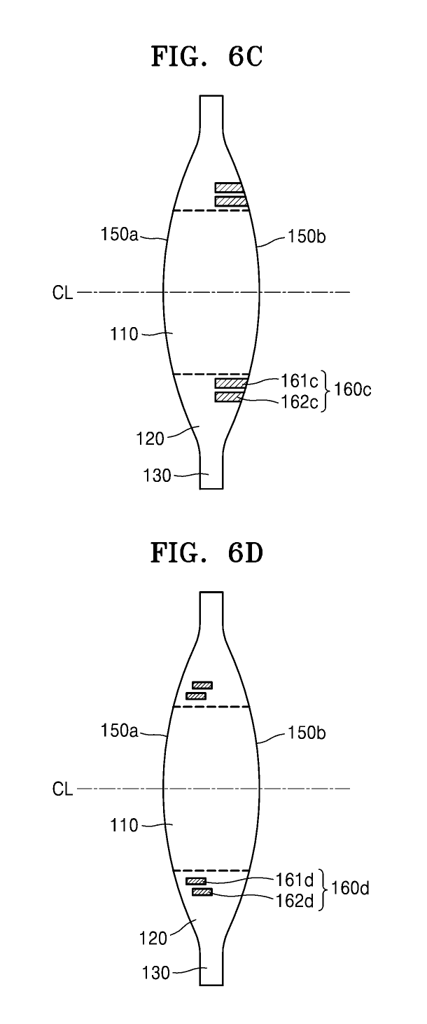

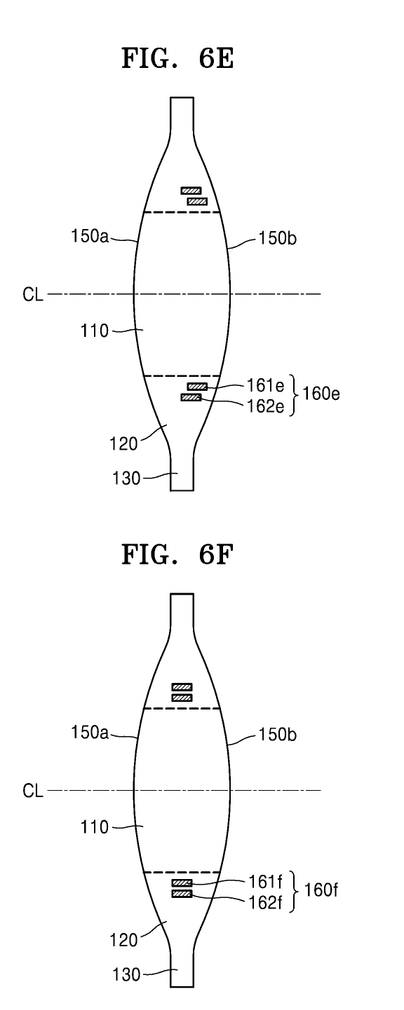

FIGS. 6A to 6F are cross-sectional views illustrating modifications of the camera lens 100 of FIG. 2. The modifications of the camera lens 100 are characteristically different in terms of the structure and arrangement of optical fiber units, and thus the differences therebetween will be mainly described below.

Referring to FIG. 6A, an optical fiber unit 160a may be inserted to connect the rear surface 150b from the front surface 150a. A first fiber unit 161a and a second fiber unit 162a may extend in the first direction from the front surface 150a to the rear surface 150b.

The optical fiber unit 160a may selectively transmit some of the external lights incident on the transition unit 120 of the front surface 150a. The optical fiber unit 160a may reflect some of the incident lights and transmit some of the incident lights according to the refractive index of the optical fiber unit 160a. Also, when the incidence angle of the external lights is greater than or equal to the critical angle of the optical fiber unit 160a, the optical fiber unit 160a may reflect all of the incident lights. Also, when the incidence angle of the external lights is in a certain range, it may transmit all of the incident lights.

The optical fiber unit 160a may transmit only some of the external lights incident on the camera lens 100, and thus a clear image may be generated on the image sensor 40. The optical fiber unit 160a may form an effect similar to a pinhole effect but the total light transmission amount and the total light transmission area may increase in comparison with the pinhole effect and thus a brighter and clearer image may be generated on the image sensor 40.

Referring to FIG. 6B, an optical fiber unit 160b may be formed to be inserted into the front surface 150a. The optical fiber unit 160b may be inserted into the front surface 150a by a certain length in the first direction and may not extend to the rear surface 150b.

For example, the optical fiber unit 160b may include a first fiber unit 161b and a second fiber unit 162b, and each of the first fiber unit 161b and the second fiber unit 162b may be inserted into the front surface 150a by a certain length in the first direction.

The optical fiber unit 160b may selectively transmit some of the external lights incident on the transition unit 120 of the front surface 150a. The optical fiber unit 160b may reflect some of the incident lights and transmit some of the incident lights according to the refractive index of the optical fiber unit 160b. Also, when the incidence angle of the external lights is greater than or equal to the critical angle of the optical fiber unit 160b, the optical fiber unit 160b may reflect all of the incident lights. Also, when the incidence angle of the external lights is in a certain range, it may transmit all of the incident lights. The optical fiber unit 160b may transmit only some of the external lights incident on the camera lens 100, and thus a clear image may be generated on the image sensor 40. The optical fiber unit 160b may form an effect similar to a pinhole effect but the total light transmission amount and the total light transmission area may increase in comparison with the pinhole effect and thus a brighter and clearer image may be generated on the image sensor 40.

Referring to FIG. 6C, an optical fiber unit 160c may be formed to be inserted into the rear surface 150b. The optical fiber unit 160c may be inserted into the rear surface 150b by a certain length in the first direction and may not extend to the front surface 150a.

For example, the optical fiber unit 160c may include a first fiber unit 161c and a second fiber unit 162c, and each of the first fiber unit 161c and the second fiber unit 162c may be inserted into the rear surface 150b by a certain length in the first direction.

The optical fiber unit 160c may selectively transmit some of the external lights incident on the transition unit 120 of the front surface 150a. The external light may be incident on the transition unit 120 and then move toward the optical fiber unit 160c.

The optical fiber unit 160c may selectively transmit some of the external lights incident on the transition unit 120 of the front surface 150a. The optical fiber unit 160c may reflect some of the incident lights and transmit some of the incident lights according to the refractive index of the optical fiber unit 160c. Also, when the incidence angle of the external lights is greater than or equal to the critical angle of the optical fiber unit 160c, the optical fiber unit 160c may reflect all of the incident lights. Also, when the incidence angle of the external lights is in a certain range, it may transmit all of the incident lights. The optical fiber unit 160c may transmit only some of the external lights incident on the camera lens 100, and thus a clear image may be generated on the image sensor 40. The optical fiber unit 160c may form an effect similar to a pinhole effect but the total light transmission amount and the total light transmission area may increase in comparison with the pinhole effect and thus a brighter and clearer image may be generated on the image sensor 40.

Referring to FIG. 6D, an optical fiber unit 160d may be arranged in the lens body 150. The optical fiber unit 160d may be arranged adjacent to the front surface of the lens body 150.

For example, the optical fiber unit 160d may include a first fiber unit 161d and a second fiber unit 162d, and each of the first fiber unit 161d and the second fiber unit 162d may be arranged in the transition unit 120 in the first direction. In this case, the first fiber unit 161d and the second fiber unit 162d may be arranged more adjacent to the front surface than the rear surface 150b.

The optical fiber unit 160d may selectively transmit some of the external lights incident on the transition unit 120 of the front surface 150a. The optical fiber unit 160d may reflect some of the incident lights and transmit some of the incident lights according to the refractive index of the optical fiber unit 160d. Also, when the incidence angle of the external lights is greater than or equal to the critical angle of the optical fiber unit 160d, the optical fiber unit 160d may reflect all of the incident lights. Also, when the incidence angle of the external lights is in a certain range, it may transmit all of the incident lights.

The optical fiber unit 160d may transmit only some of the external lights incident on the camera lens 100, and thus a clear image may be generated on the image sensor 40. The optical fiber unit 160d may form an effect similar to a pinhole effect but the total light transmission amount and the total light transmission area may increase in comparison with the pinhole effect and thus a brighter and clearer image may be generated on the image sensor 40.

Referring to FIG. 6E, an optical fiber unit 160e may be arranged in the lens body 150. The optical fiber unit 160e may be arranged adjacent to the rear surface of the lens body 150.

For example, the optical fiber unit 160e may include a first fiber unit 161e and a second fiber unit 162e, and each of the first fiber unit 161e and the second fiber unit 162e may be arranged in the transition unit 120 in the first direction. In this case, the first fiber unit 161e and the second fiber unit 162e may be arranged more adjacent to the rear surface 150b than the front surface 150a.

The optical fiber unit 160e may selectively transmit some of the external lights incident on the transition unit 120 of the front surface 150a. The optical fiber unit 160e may reflect some of the incident lights and transmit some of the incident lights according to the refractive index of the optical fiber unit 160e. Also, when the incidence angle of the external lights is greater than or equal to the critical angle of the optical fiber unit 160e, the optical fiber unit 160e may reflect all of the incident lights. Also, when the incidence angle of the external lights is in a certain range, it may transmit all of the incident lights. The optical fiber unit 160e may transmit only some of the external lights incident on the camera lens 100, and thus a clear image may be generated on the image sensor 40. The optical fiber unit 160e may form an effect similar to a pinhole effect but the total light transmission amount and the total light transmission area may increase in comparison with the pinhole effect and thus a brighter and clearer image may be generated on the image sensor 40.

Referring to FIG. 6F, an optical fiber unit 160f may be arranged in the lens body 150. The optical fiber unit 160f may be arranged at the center of the thickness of the lens body 150.

For example, the optical fiber unit 160f may include a first fiber unit 161f and a second fiber unit 162f, and each of the first fiber unit 161f and the second fiber unit 162f may be arranged in the transition unit 120 in the first direction. In this case, the first fiber unit 161e and the second fiber unit 162e may be arranged between the front surface 150a and the rear surface 150b.

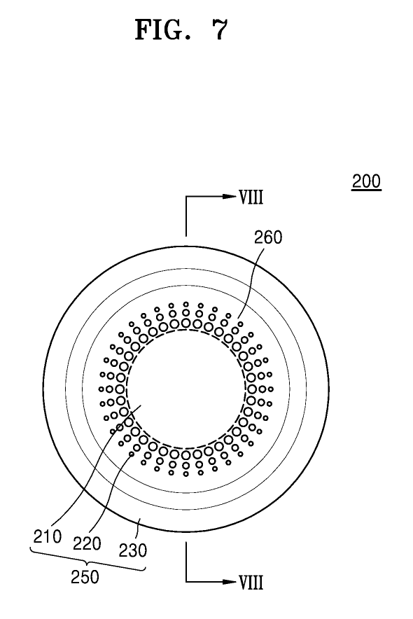

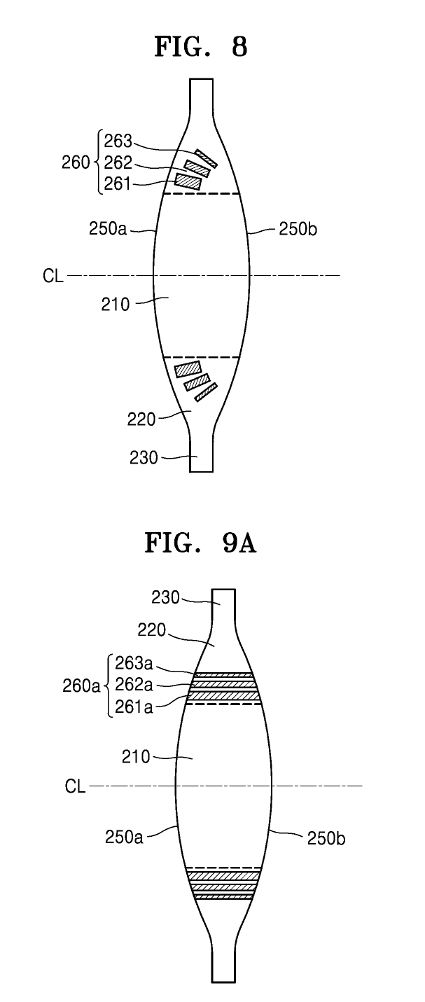

FIG. 7 is a perspective view illustrating a camera lens 200 according to another embodiment of the present disclosure, and FIG. 8 is a cross-sectional view taken along line VIII-VIII of FIG. 7.

Referring to FIGS. 7 and 8, the camera lens 200 may include a lens body 250 and an optical fiber unit 260. The lens body 250 may include a central optical unit 210, a transition unit 220, and an edge unit 230. However, the other embodiment of the present disclosure may be characteristically different from the original embodiment only in that the shape and arrangement of the optical fiber units 260 are formed differently. Therefore, in the description of the present embodiment, portions not described herein may be the same as those in the above embodiment and thus redundant descriptions thereof will be omitted for conciseness.

A plurality of optical fiber units 260 may be arranged in the radial direction of the central optical unit 210, and the diameters of the optical fiber units 260 may decrease in the radial direction. Hereinafter, for convenience of description, the case of forming three fiber units will be mainly described.

Particularly, the optical fiber unit 260 may include a first fiber unit 261 adjacent to the central optical unit 210 and arranged in a circular shape along the central optical unit 210 and a second fiber unit 262 arranged on an outer side of the first fiber unit 261 in the radial direction. Also, the optical fiber unit 260 may include a third fiber unit 263 arranged on an outer side of the second fiber unit 262 in the radial direction. The diameter of the first fiber unit 261 arranged closest to the central optical unit 210 may be the greatest and the diameter of the third fiber unit 263 arranged at the outermost side thereof may be the smallest.

The optical fiber unit 260 may form a certain angle with respect to each of the length direction and the first direction. The optical fiber unit 260 may form a certain angle with respect to a central line CL of the central optical unit 210. Also, the angle may increase in the radial direction of the central optical unit 210. The external light incident on the central optical unit 210 may pass through the central optical unit 210 to form a bright and clear image on the image sensor 40. Also, the light passing through the central optical unit 210 may increase the brightness of a formed image.

A plurality of optical fiber units may be arranged in the radial direction of the central optical unit, and the diameter of the optical fiber unit may decrease in the radial direction. When the diameter of the first fiber unit 261 is designed to be greater, a larger amount of light aligned in the image sensor 40 may be secured. Since the focal depth of the aligned light is improved, it may be possible to provide the camera lens 200 capable of performing an aperture function by securing the aligned light as much as possible. Also, when the diameter of the third fiber unit 263 is reduced, the density of optical fiber included in the same area may be increased and the light may be incident at a great incidence angle toward the outside of the camera lens 200 and thus the light hindering the improvement of the focal depth may be effectively blocked.

In another embodiment, when the diameter of the first fiber unit 261 is reduced, the area occupied by the first fiber unit 261 in the transition unit 220 may be reduced. Thus, the amount of light incident on the transition unit 220 may increase relatively. Since the first fiber unit 261 is arranged adjacent to the central optical unit 210, the transmission amount of the light incident on a region close to the central optical unit 210 may be increased and the transmission amount of the light incident on a region distant from the central optical unit 210 may be reduced. Thus, the camera lens 200 performing a function of an aperture may be provided.

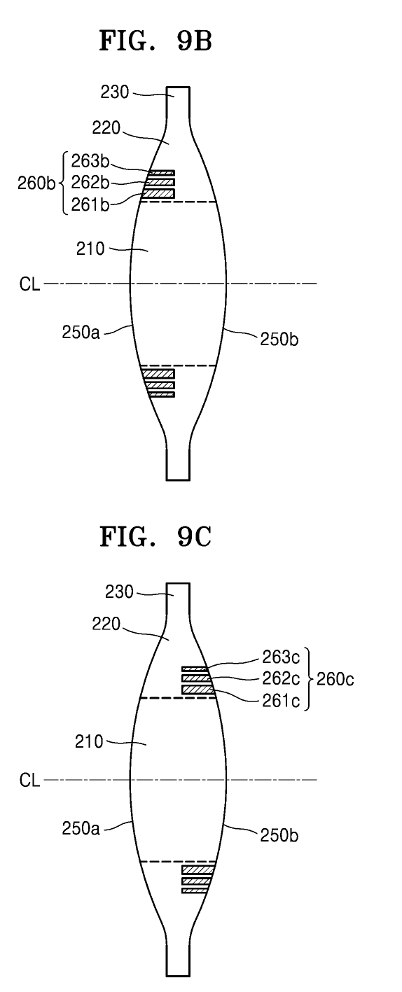

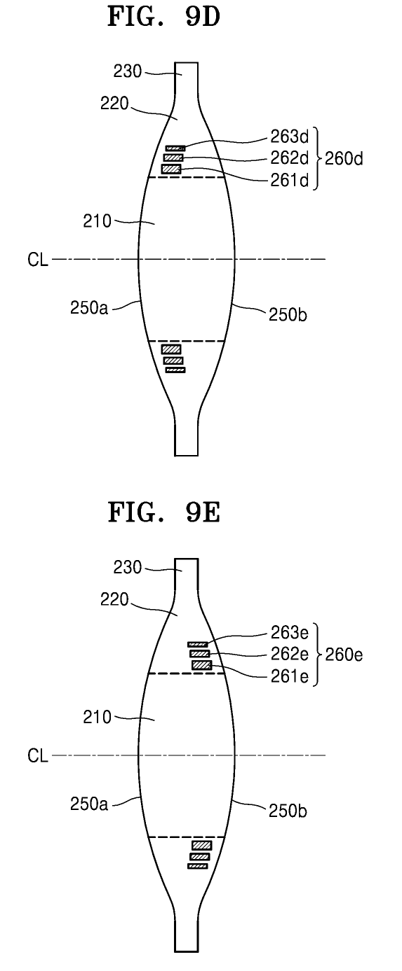

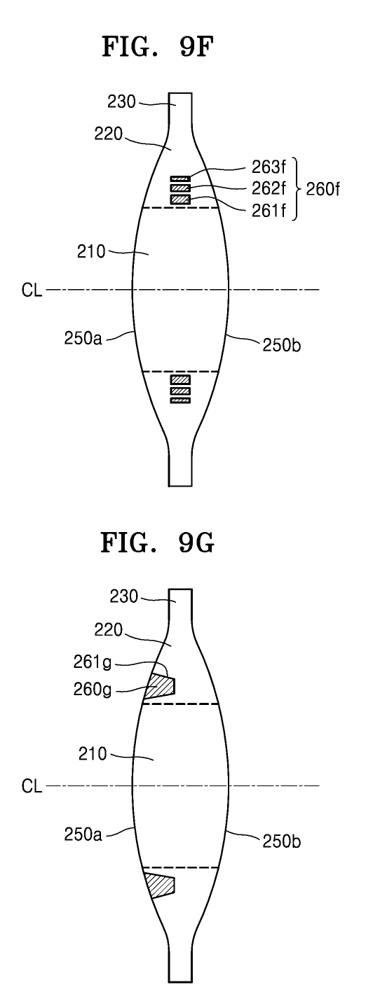

FIGS. 9A to 9G are cross-sectional views illustrating modifications of the camera lens 200 of FIG. 7. The modifications of the camera lens 200 are characteristically different in terms of the structure and arrangement of optical fiber units, and thus the differences therebetween will be mainly described below.

Referring to FIG. 9A, an optical fiber unit 260a may be inserted to connect a rear surface 250b from a front surface 250a. For example, the optical fiber unit 260a may include a first fiber unit 261a, a second fiber unit 262a, and a third fiber unit 263a, and each of them may extend to the rear surface 250b in the first direction. The diameter of the first fiber unit 261a arranged closest to the central optical unit 210 may be the greatest and the diameter of the third fiber unit 263a arranged at the outermost side thereof may be the smallest.

Referring to FIG. 9B, an optical fiber unit 260b may be formed to be inserted into the front surface 250a. The optical fiber unit 260b may be inserted into the front surface 250a by a certain length in the first direction and may not extend to the rear surface 250b.

For example, the optical fiber unit 260b may include a first fiber unit 261b, a second fiber unit 262b, and a third fiber unit 263b, and each of them may be inserted into the front surface 250a by a certain length in the first direction. The diameter of the first fiber unit 261b arranged closest to the central optical unit 210 may be the greatest and the diameter of the third fiber unit 263b arranged at the outermost side thereof may be the smallest.

Referring to FIG. 9C, an optical fiber unit 260c may be formed to be inserted into the rear surface 250b. The optical fiber unit 260c may be inserted into the rear surface 250b by a certain length in the first direction and may not extend to the front surface 250a.

For example, the optical fiber unit 260c may include a first fiber unit 261c, a second fiber unit 262c, and a third fiber unit 263c, and each of them may be inserted into the rear surface 250b by a certain length in the first direction. The diameter of the first fiber unit 261c arranged closest to the central optical unit 210 may be the greatest and the diameter of the third fiber unit 263c arranged at the outermost side thereof may be the smallest.

Referring to FIG. 9D, an optical fiber unit 260d may be arranged in the lens body 250. The optical fiber unit 260d may be arranged adjacent to the front surface of the lens body 250.

For example, the optical fiber unit 260d may include a first fiber unit 261d, a second fiber unit 262d, and a third fiber unit 263d, and each of them may be arranged in the transition unit 220 in the first direction. In this case, the first fiber unit 261d, the second fiber unit 262d, and the third fiber unit 263d may be arranged more adjacent to the front surface than the rear surface 250b.

The diameter of the first fiber unit 261d arranged closest to the central optical unit 210 may be the greatest and the diameter of the third fiber unit 263d arranged at the outermost side thereof may be the smallest.

Referring to FIG. 9E, an optical fiber unit 260e may be arranged in the lens body 250. The optical fiber unit 260e may be arranged adjacent to the rear surface of the lens body 250.

For example, the optical fiber unit 260e may include a first fiber unit 261e, a second fiber unit 262e, and a third fiber unit 263e, and each of them may be arranged in the transition unit 220 in the first direction. In this case, the first fiber unit 261e, the second fiber unit 262e, and the third fiber unit 263e may be arranged more adjacent to the rear surface 250b than the front surface 250a.

The diameter of the first fiber unit 261e arranged closest to the central optical unit 210 may be the greatest and the diameter of the third fiber unit 263e arranged at the outermost side thereof may be the smallest.

Referring to FIG. 9F, an optical fiber unit 260f may be arranged in the lens body 250. The optical fiber unit 260f may be arranged at the center of the thickness of the lens body 250.

For example, the optical fiber unit 260f may include a first fiber unit 261f, a second fiber unit 262f, and a third fiber unit 263f, and each of them may be arranged in the transition unit 220 in the first direction. In this case, the first fiber unit 261f and the second fiber unit 262f may be arranged between the front surface 250a and the rear surface 250b.

FIG. 9G is a cross-sectional view illustrating another modification of the camera lens 200 of FIG. 7. The modification of the camera lens 200 is characteristically different in terms of the structure and arrangement of an optical fiber unit, and thus the difference will be mainly described below.

An optical fiber unit 260g may be formed such that an outer wall 261g thereof is tapered. The optical fiber unit 260g may include the outer wall 261g tapered in the first direction. Particularly, the optical fiber unit 260g may have a large cross section formed on the front surface 250a and a smaller cross section toward the rear surface 250b. Some of the lights incident on the optical fiber unit 260g may collide with the tapered outer wall 261g. That is, some of the lights passing through the optical fiber unit 260g may again collide with the outer wall 261g to reduce the amount of light passing through the optical fiber unit 260g. Even when the volume of the optical fiber unit 260g is reduced by the tapered outer wall 261g, the optical fiber unit 260g may effectively align the lights by re-reflecting the incident lights.

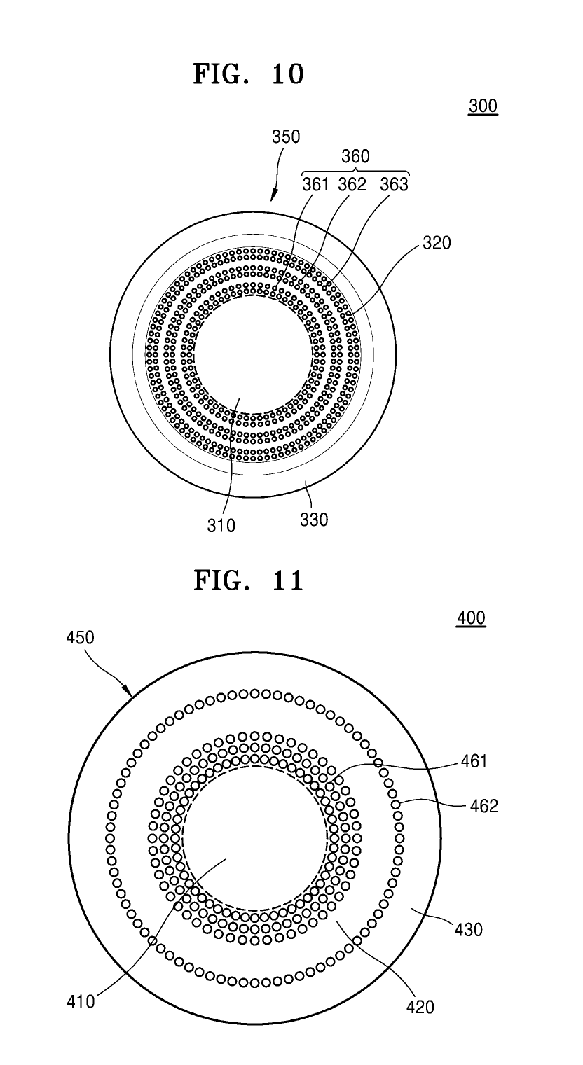

FIG. 10 is a perspective view illustrating a camera lens 300 according to another embodiment of the present disclosure.

Referring to FIG. 10, the camera lens 300 may include a lens body 350 and an optical fiber unit 360. The lens body 350 may include a central optical unit 310, a transition unit 320, and an edge unit 330. However, the other embodiment of the present disclosure may be characteristically different from the original embodiment only in that the shape and arrangement of the optical fiber units 360 are formed differently. Therefore, in the description of the present embodiment, portions not described herein may be the same as those in the above embodiment and thus redundant descriptions thereof will be omitted for conciseness.

The optical fiber unit 360 may form a plurality of bands. The optical fiber unit 360 may be arranged in the transition unit 320 and may be arranged at certain intervals in the radial direction. The number of bands including the optical fiber unit 360 is not limited to a particular number. Hereinafter, for convenience of description, the case of having three bands will be mainly described.

Particularly, the optical fiber unit 360 may include a first fiber band 361 arranged on an outer side of the central optical unit 310, a second fiber band 362 arranged on an outer side of the first fiber band 361, and a third fiber band 363 arranged on an outer side of the second fiber band 362. The first fiber band 361 and the second fiber band 362 may be arranged at a certain interval therebetween, and the second fiber band 362 and the third fiber band 363 may be arranged at a certain interval therebetween. Each of the fiber bands may be formed at a certain angle with respect to a central line CL of the lens body 350 or may be arranged to contact any one surface thereof. Also, it may be arranged adjacent to any one surface of the lens body 350 with a gap therebetween or and may be arranged at the center of the lens body 350. A description thereof may be the same as that of the original embodiment described above.

The camera lens 300 may increase the amount of light incident on the interval between the fiber bands to secure a field of view. That is, a field of view may be increased due to the externally incident light passing through the interval between the fiber bands.

FIG. 11 is a perspective view illustrating a camera lens 400 according to another embodiment of the present disclosure.

Referring to FIG. 11, the camera lens 400 may include a lens body 450 and optical fiber units 461 and 462. The lens body 450 may include a central optical unit 410, a transition unit 420, and an edge unit 430. However, the other embodiment of the present disclosure may be characteristically different from the original embodiment only in that the shape and arrangement of the optical fiber units 461 and 462 are formed differently. Therefore, in the description of the present embodiment, portions not described herein may be the same as those in the above embodiment and thus redundant descriptions thereof will be omitted for conciseness.

The optical fiber unit may form a plurality of bands. Particularly, the first optical fiber unit 461 may form a plurality of bands on the outer side of the central optical unit 410, and the second optical fiber unit 462 may be arranged between the transition unit 420 and the edge unit 430. The second optical fiber unit 462 may form a smaller number of bands than the first optical fiber unit 461.

Since the main light for image formation is incident on the central optical unit 410, the first optical fiber unit 461 may form a plurality of bands on the outer side of the central optical unit 410 to align a large amount of light. On the other hand, the second optical fiber unit 462 may be arranged in the outer portion of the lens body 450 to align some light with a great incidence angle. That is, due to the arrangement of the first optical fiber unit 461 and the second optical fiber unit 462, the lights incident on the lens body 450 may be effectively aligned.

The first optical fiber unit 461 may have a plurality of fiber bands along the central optical unit 410, and each band may be arranged to have a certain interval. Each of the fiber bands may be formed at a certain angle with respect to a central line CL of the lens body 450 or may be arranged to contact any one surface thereof. Also, it may be arranged adjacent to any one surface of the lens body 450 with a gap therebetween or and may be arranged at the center of the lens body 450. A description thereof may be the same as that of the original embodiment described above.

The camera lens 400 may increase the amount of light incident on the interval between the fiber bands to secure a field of view. That is, a field of view may be increased due to the externally incident light passing through the interval between the fiber bands.

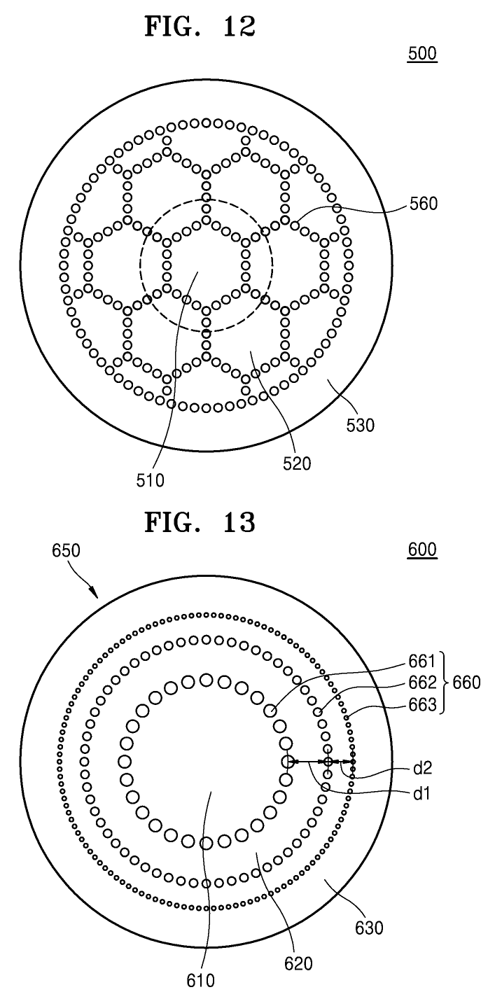

FIG. 12 is a perspective view illustrating a camera lens 500 according to another embodiment of the present disclosure.

Referring to FIG. 12, the camera lens 500 may include a lens body 550 and an optical fiber unit 560. The lens body 550 may include a central optical unit 510, a transition unit 520, and an edge unit 530. However, the other embodiment of the present disclosure may be characteristically different from the original embodiment only in that the shape and arrangement of the optical fiber units 560 are formed differently. Therefore, in the description of the present embodiment, portions not described herein may be the same as those in the above embodiment and thus redundant descriptions thereof will be omitted for conciseness.

The optical fiber unit 560 may form a plurality of loops throughout the lens body 550. The optical fiber unit 560 may form fiber loops connected to each other, and each fiber loop may have a closed shape.

Since the external lights passing through the optical fiber unit 560 are aligned, the lights entering the inside of the fiber loop may pass through the lens body 550. Since the optical fiber unit 560 has a regular arrangement, it may regularly align the externally incident lights.

The camera lens 500 may increase the amount of light incident on the interval between the fiber loops to secure a field of view. That is, a field of view may be increased due to the externally incident light passing through the interval between the fiber loops, and the focal depth may be improved by aligning the external lights by the fiber loops.

FIG. 13 is a perspective view illustrating a camera lens 600 according to another embodiment of the present disclosure.

Referring to FIG. 13, the camera lens 600 may include a lens body 650 and an optical fiber unit 660. The lens body 650 may include a central optical unit 610, a transition unit 620, and an edge unit 630. However, the other embodiment of the present disclosure may be characteristically different from the original embodiment only in that the shape and arrangement of the optical fiber units 660 are formed differently. Therefore, in the description of the present embodiment, portions not described herein may be the same as those in the above embodiment and thus redundant descriptions thereof will be omitted for conciseness.

A plurality of optical fiber units 660 may form fiber bands in the circumferential direction, and the fiber bands may be arranged spaced apart in the radial direction. In FIG. 13, the optical fiber unit 660 may include a first fiber band 661, a second fiber band 662, and a third fiber band 663. However, the number of fiber bands is not limited thereto and may be variously selected.

The diameter of each fiber band of the optical fiber unit 660 may decrease in the radial direction. That is, the diameter of the first fiber band 661 may be greater than the diameter of the second fiber band 662, and the diameter of the second fiber band 662 may be greater than the diameter of the third fiber band 663. When the diameter of the fiber band is great, since the amount of light incident on the optical fiber increases, a larger amount of light may be aligned. Since the first fiber band 661 having the greatest diameter is arranged at the central optical unit 610, the lights incident at the center thereof may be aligned. Since the amount of light aligned in a central portion thereof increases, the focal depth may be effectively improved.

The interval between the fiber bands of the optical fiber unit 660 may decrease in the radial direction. That is, a distance d1 between the first fiber band 661 and the second fiber band 662 may be greater than a distance d2 between the second fiber band 662 and the third fiber band 663. Since the distance d1 between the first fiber band 661 and the second fiber band 662 arranged at the central optical unit 610 is relatively great, the light passing through the center with a small incidence angle may pass through d1 and thus a bright image may be effectively formed.

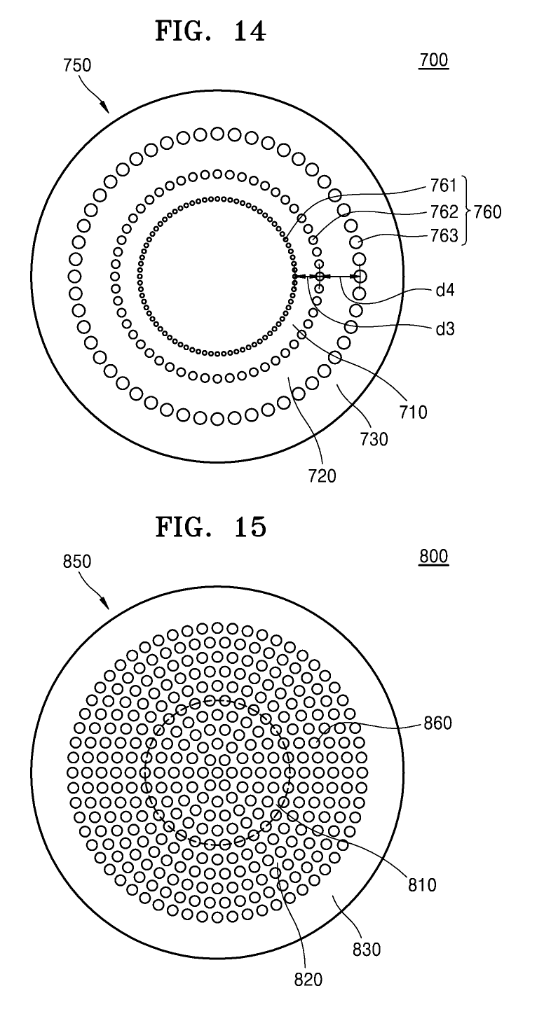

FIG. 14 is a perspective view illustrating a camera lens 700 according to another embodiment of the present disclosure.

Referring to FIG. 14, the camera lens 700 may include a lens body 750 and an optical fiber unit 760. The lens body 750 may include a central optical unit 710, a transition unit 720, and an edge unit 730. However, the other embodiment of the present disclosure may be characteristically different from the original embodiment only in that the shape and arrangement of the optical fiber units 760 are formed differently. Therefore, in the description of the present embodiment, portions not described herein may be the same as those in the above embodiment and thus redundant descriptions thereof will be omitted for conciseness.

A plurality of optical fiber units 760 may form fiber bands in the circumferential direction, and the fiber bands may be arranged spaced apart in the radial direction. In FIG. 14, the optical fiber unit 760 may include a first fiber band 761, a second fiber band 762, and a third fiber band 763. However, the number of fiber bands is not limited thereto and may be variously selected.

The diameter of each fiber band of the optical fiber unit 760 may increase in the radial direction. That is, the diameter of the first fiber band 761 may be smaller than the diameter of the second fiber band 762, and the diameter of the second fiber band 762 may be smaller than the diameter of the third fiber band 763. When the diameter of the fiber band is great, since the amount of light incident on the optical fiber increases, a larger amount of light may be aligned. Since the third fiber band 763 having the greatest diameter is arranged at the outermost portion of the central optical unit 710, the lights with a great incidence angle may be aligned.

The interval between the fiber bands of the optical fiber unit 760 may increase in the radial direction. That is, a distance d3 between the first fiber band 761 and the second fiber band 762 may be smaller than a distance d4 between the second fiber band 762 and the third fiber band 763. Since the distance d3 between the first fiber band 761 and the second fiber band 762 arranged at the central optical unit 710 is relatively small, the incident lights may be effectively aligned although the diameters of the first fiber band 761 and the second fiber band 762 are relatively small.

FIG. 15 is a perspective view illustrating a camera lens 800 according to another embodiment of the present disclosure.

Referring to FIG. 15, the camera lens 800 may include a lens body 850 and an optical fiber unit 860. The lens body 850 may include a central optical unit 810, a transition unit 820, and an edge unit 830. However, the other embodiment of the present disclosure may be characteristically different from the original embodiment only in that the shape and arrangement of the optical fiber units 860 are formed differently. Therefore, in the description of the present embodiment, portions not described herein may be the same as those in the above embodiment and thus redundant descriptions thereof will be omitted for conciseness.

The optical fiber unit 860 may be regularly arranged throughout the central optical unit 810 and the transition unit 820. Since the proportion of the optical fiber unit 860 in the lens body 850 is high, the lights incident on the lens body 850 may be aligned. When a plurality of external light sources are arranged in various directions, lights with a small incidence angle and lights with a great incidence angle are arranged in the lens body 850 in a mixed manner. In this case, it may be necessary to align all the lights incident throughout the lens body 850. Since the optical fiber unit 860 is arranged throughout the central optical unit 810 and the transition unit 820, even when the lights with a great incidence angle are incident on the entire surface of the lens in a mixed manner, the lights with a great incidence angle may be effectively aligned.

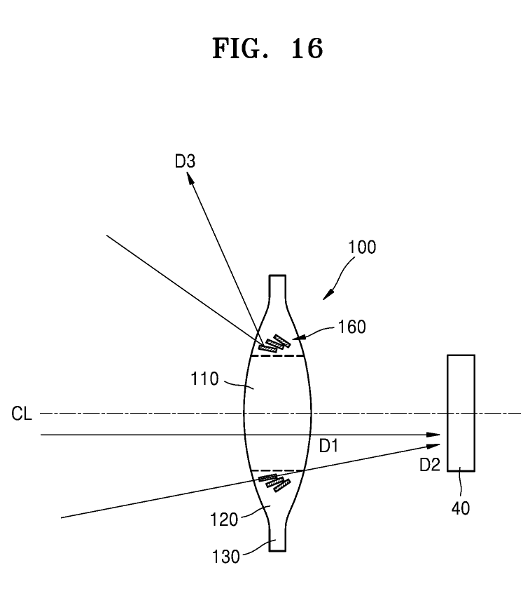

FIG. 16 is a conceptual diagram illustrating external lights incident on the camera lens 100 of FIG. 2.

Referring to FIG. 16, a clear image may be generated by the camera lens 100.

A general camera lens includes an aperture for securing a light amount. An opening of the aperture is arranged at a center thereof. However, since the opening of the aperture has to be arranged to be small in the center of the lens, there is a limit to securing a sufficient light amount.

The camera lens 100 according to the present disclosure may form a clear image by aligning the lights incident at a small or medium distance.

D1 represents the light incident at a great distance, and D2 and D3 represent the light incident at a small or medium distance. D2 indicates that the light passes through the optical fiber unit 160, and D3 indicates that the light is reflected by the side wall of the optical fiber unit 160 due to a great incidence angle thereof.

Like D1, the light incident at a great distance may vertically enter and pass through the central optical unit 110 or the optical fiber unit 160. That is, most of the lights incident at a great distance may pass through the camera lens 100.

Like D2, when the light with a small incidence angle is incident at a small or medium distance, that is, when the light is substantially vertically incident on the camera lens, the light may pass through the optical fiber unit 160. The light with a small incidence angle may pass through both the central optical unit 110 and the optical fiber unit 160, thus improving the focal depth.

On the other hand, like D3, when the light with a great incidence angle is incident at a small or medium distance, the light may be reflected by the optical fiber unit 160. That is, in the camera lens 100, in the case of a great incidence angle α t a small distance, the light directed toward the central optical unit 110 may pass therethrough, while the light directed toward the optical fiber unit 160 may be reflected thereby unlike in the central optical unit 110.

Particularly, the light may be reflected at the side surface of the optical fiber unit 160. Since the refractive index of the optical fiber unit 160 is different from that of the transition unit 120, the light with a great incidence angle may pass through the transition unit 120 and may be reflected at the side surface of the optical fiber unit 160 due to a difference in the refractive index.

Also, a light absorbing paint or the like may be applied on the side surface of the optical fiber unit 160. The light with a great incidence angle may pass through the transition unit 120 or may be absorbed through the paint on the side surface of the optical fiber unit 160.

The camera lens 100 may selectively transmit only some of the incident lights and may improve the focal depth by aligning the lights in the optical fiber unit 160. That is, the optical fiber unit 160 may form an effect similar to a pinhole effect, and thus a clear image may be formed on the image sensor 40.

The camera lens 100 may form a clear image by transmitting the lights incident on the central optical unit 110 and selectively transmitting the lights incident on the optical fiber unit 160.

The camera lens according to the embodiments of the present disclosure may improve the focal depth by aligning the lights through the optical fiber unit and minimizing the mutual interference of the lights. Also, the camera lens according to the embodiments of the present disclosure may adjust the brightness of an image formed on the image sensor by adjusting the amount of light passing through the central optical unit.

Also, since the camera lens according to the embodiments of the present disclosure aligns the incident lights, it may perform a function of an aperture by itself. Since the aperture may be replaced, the movement of the lens may be unnecessary or small and thus the thickness of a camera module may be reduced. Also, the adjustment time for setting an optimal focus may be reduced and the cost thereof may be reduced.

Also, even when the aperture is installed together with the camera lens according to the embodiments of the present disclosure, since the size of an opening of the aperture may be increased, a sufficient light amount may be secured. Thus, the image quality may be improved in the case of photographing in a dark place.

Although the present disclosure has been described with reference to the above embodiments, various changes or modifications may be made therein without departing from the spirit and scope of the present disclosure. Thus, the appended claims will include all such changes or modifications falling within the spirit and scope of the present disclosure.

According to an embodiment of the present disclosure, a camera lens and a camera lens assembly that improve focal depth are provided, and embodiments of the present disclosure may be applied to optical instruments such as cameras including industrial optical lenses.

What is claimed is:

1. A camera lens comprising:
a lens body having a front surface and a rear surface and comprising a central optical unit formed at a center thereof; and
a plurality of optical fiber units arranged such that at least some thereof are included in the lens body, and having a different refractive index than the lens body.

2. The camera lens of claim 1, wherein the optical fiber unit comprises any one selected from glass fiber and optical fiber.

3. The camera lens of claim 1, wherein lights directed to the central optical unit pass through the central optical unit, and some of the lights directed to the optical fiber unit pass through the optical fiber unit.
